(19) United States
(12) Patent Application Publication
(10) Pub. No.: US 2015/0114058 A1
(43) Pub. Date: Apr. 30, 2015

(54) Rotary Locking Cylinder and Security Key

(71) Applicant: Ernst Keller, Wollerau SZ (CH)

(72) Inventor: Ernst Keller, Wollerau SZ (CH)

(21) Appl. No.: 14/240,881

(22) PCT Filed: Aug. 23, 2012
(86) PCT No.: PCT/EP2012/066402

§ 371 Date: Jul. 14, 2014

(30) Foreign Application Priority Data
Aug. 26, 2011 (EP) 11179018.4

(51) Int. Cl. E05B 27/00

(52) U.S. Cl. CPC E05B 27/0003
USPC 70/350

(57) ABSTRACT

A rotary locking cylinder includes a housing and a rotor mounted therein. Furthermore, tumblers influencing the combinatorics each have a core pin, a housing pin, and a key channel incorporated into the rotor. The tumblers are arranged in the keyway by inserting the security key. The at least two tumblers are mechanically controlled by the security key so that they are arranged radially in different directions. At least one of the tumblers is pulled against the keyway by the security key for arrangement. Furthermore, the at least one tumbler is struck and arranged by a front key tip of the security key.

The invention relates to a rotary locking cylinder and security key, wherein the rotary locking cylinder has a housing and a rotor mounted in the latter and also tumblers which influence the combinatorics and each have a core pin and a housing pin, and a key channel which is incorporated into the rotor, which tumblers are coordinated by the key being pushed into the keyway. In such rotary locking cylinders, the core pins and/or housing pins can also be in multipart form.

In rotary locking cylinders, the tumblers which influence the combinatorics are brought into line by the associated security key by said tumblers each being moved outward counter to a reacting force of a spring. Such a rotary locking cylinder has been disclosed in the prior art, for example, by EP-A-1 523 603. In this case, the control surfaces of the associated security key, which control surfaces bring the tumblers into line, are bores in the security key. However, the control surfaces can also be other surfaces, for example surfaces which are formed by grooves or the like. What are referred to as cam keys, in which the core pins are guided on cams of the security key, are also known. By means of the control surfaces, the spring-loaded tumblers are pushed to locking height by one or more increments. If all of the tumblers are brought into line, the rotor is released and can be rotated by the security key. A bolt of the lock is then customarily displaced via a driver. As is known, frequent attempts are made to manipulate such rotary locking cylinders. There are accordingly numerous proposals as to how the security against manipulations can be increased. In the prior art, keys which have a blocking pin which is coordinated by a magnet of the security key are known, for example, from U.S. Pat. No. 4,627,251. However, such rotary locking cylinders have not proven successful in practice. In addition, they can easily be manipulated.

The invention is based on the object of providing a rotary locking cylinder of the type mentioned, which permits even greater security against manipulations. The object is achieved as per claim 1. In the rotary locking cylinder according to the invention, at least two tumblers, mechanically controlled by the security key, are brought into line radially in different directions. For bringing the tumblers into line, one of the two tumblers is therefore pushed outward, as customary. As a rule, a plurality of such tumblers are moved outward with a different increment. By contrast, for displacement in the opposite direction, i.e. radially inward, at least one of the two tumblers is moved by the security key. In the basic position, said tumbler blocks the rotor preferably by means of the core pin and is therefore positive. Said core pin is preferably moved inward to be brought into line counter to a comparatively strong spring. In addition to the greater security mentioned against manipulation, such a rotary locking cylinder also provides increased protection against duplication for the security key. Such a security key cannot be readily duplicated even using very costly machines. The invention also relates to a security key for a rotary locking cylinder as claimed in claim 1.

In a development of the invention, it is provided that the at least two tumblers lie in one or two radial planes running through the rotor axis of the rotor. The center axes of the tumblers and of the pins therefore lie in the radial plane. This arrangement has the advantage that the tumblers and pins can be formed in a rotationally symmetrical manner with respect to the center axes thereof, as a result of which the rotary locking cylinder can be produced simply and, above all, economically. An alignment or positional fixing, as in the case of tumblers, outside the radial planes is superfluous.

According to a development of the invention, it is provided that at least one of the tumblers is drawn radially inward by the security key and therefore counter to the key channel for bringing the tumblers into line. However, an embodiment in which more than one such tumbler is drawn radially inward by the security key counter to the key channel for bringing the tumblers into line is also conceivable. According to a development of the invention, it is provided that at least one of the tumblers is grasped by a front tip of the key and controlled. In principle, however, such a tumbler can also be arranged at a distance from the tip of the security key. Apart from the movement mentioned radially inward, it would also be conceivable first of all to move the tumbler radially outward and then radially inward for coordination purposes.

The core pins and the housing pins of the tumblers are preferably formed in a rotationally symmetrical manner with respect to the center axis thereof. An alignment of the tumblers is therefore dispensed with.

According to a development of the invention, it is provided that at least one of the tumblers is moved radially inward out of a basic position by control means of the security key for bringing the tumblers into line. The tumbler is therefore inevitably moved radially inward in order to be brought into line. As already mentioned, this movement takes place counter to the reacting force of a spring. In the basic position, the core pin projects here with a front end into the keyway. Said key channel can be open or else closed.

According to a development of the invention, it is provided that the security key has a tip which is produced separately and is fastened to the security key. In principle, a security key in which the tip has not been produced separately is also conceivable.

According to a development of the invention, it is provided that the tip is produced from a harder material than the remaining region of the security key. This substantially increases the service life of the security key. The tip can be produced, for example, from steel and the remaining region can customarily be produced from nickel silver or other suitable materials. Of course, however, instead of steel, other comparatively hard materials and in particular metals are also conceivable here.

According to a development of the invention, it is provided that the tip is fastened releasably to the security key. The tip can be fastened, for example, by means of a pin. However, the tip could basically also be connected fixedly to the security key. The tip is in particular exchangeable.

According to a development of the invention, it is provided that the security key is a turning key and correspondingly has rotationally symmetrical means with which in each case one tumbler can be drawn inward for coordination purposes. Said means are therefore arranged in a rotationally symmetrical manner. The control means can be arranged on the key shank and/or on the key tip.

Said means are, for example, radial cams with which the core pin is controlled such that the latter can be drawn inward for coordination purposes. Such control surfaces or radial cams are arranged on a narrow side of the key or the tip, for example within a groove. In principle, the key can also be a non-turning key.

Particularly preferably, at least one radial cam is arranged on each edgeways side of the security key, the radial cams being formed identically to one another. The edgeways side here is the narrow side of the key shank. The radial cam is particularly preferably arranged centrally in the edgeways side.

The radial cam is preferably arranged at the front end in the region of the key tip and/or on the key shank itself.

A security key without a radial cam moves the core pin, which projects into the keyway, outward (FIG. 14), and positively locks and blocks the rotor.

According to a development of the invention, it is provided that at least one narrow side of the security key has a groove in which an end of a core pin, which end projects into the keyway, can be controlled by the radial cam when the security key is pushed in. The groove provides the radial cam.

According to a development of the invention, it is provided that the groove mentioned is arranged at a front end or on a tip of the security key. Said groove is preferably open at the front.

According to a development of the invention, it is provided that at least one core pin has a collar on an inner end projecting into the keyway, said collar forming a control means by which said core pin can be grasped and brought into line. However, instead of a collar, other means, for example cams or the like, by which said core pin can be grasped and controlled, are also possible here.

According to a development of the invention, it is provided that at least one of the tumblers has a core pin which has a compression spring which is supported on the rotor and positions the core pin radially outward. The corresponding tumbler consists of the core pin mentioned and a housing pin. The housing pin is loaded by a compression spring which is substantially weaker than the spring of the core pin. In the basic position, the core pin therefore projects in a predetermined length into the key channel and into the cylinder housing. In the basic position, the core pin therefore blocks the cylinder core. The remaining tumblers block the cylinder core and the rotor with the housing pin and therefore in a negative manner. Said core pin is preferably of approximately mushroom-shaped design. It has a head on which the core pin is guided in a bore in the rotor. For installation purposes, the core pin can be of two-part design.

Exemplary embodiments of the invention are explained below in more detail with reference to the drawing, in which:

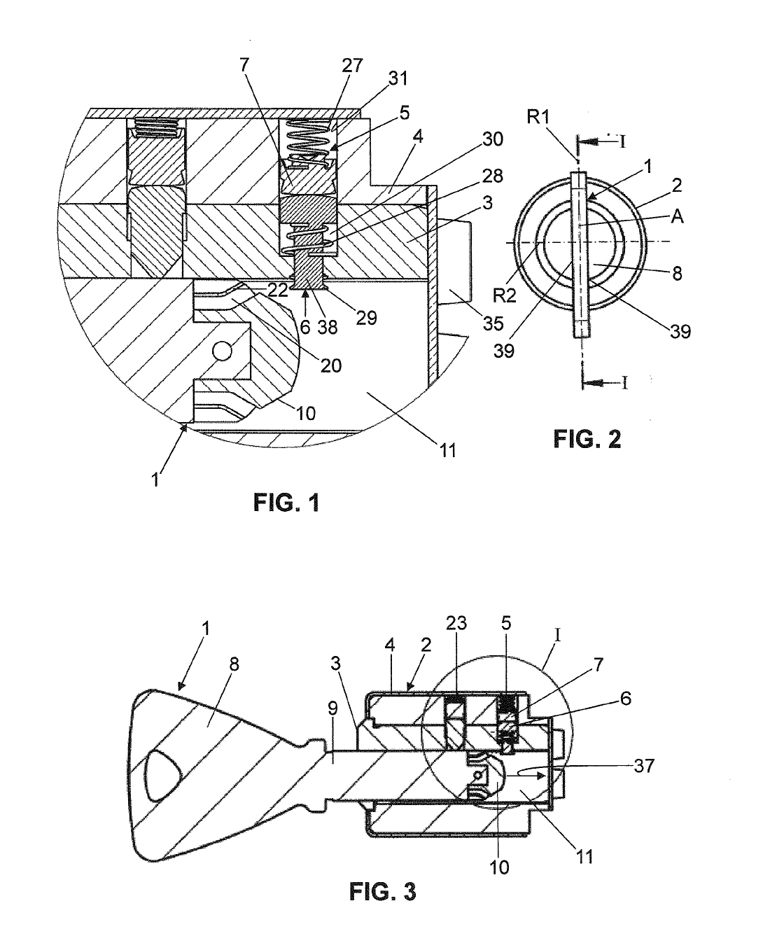

FIG. 1 shows a partial section through a rotary locking cylinder according to the invention along the line I-I in FIG. 2, wherein the security key is only partially inserted into the keyway,

FIG. 2 shows a front view of the rotary locking cylinder,

FIG. 3 shows a rotary locking cylinder and an associated security key which, as shown in FIG. 1, is not completely inserted into the keyway, wherein just one of the customary tumblers is indicated by dashed lines,

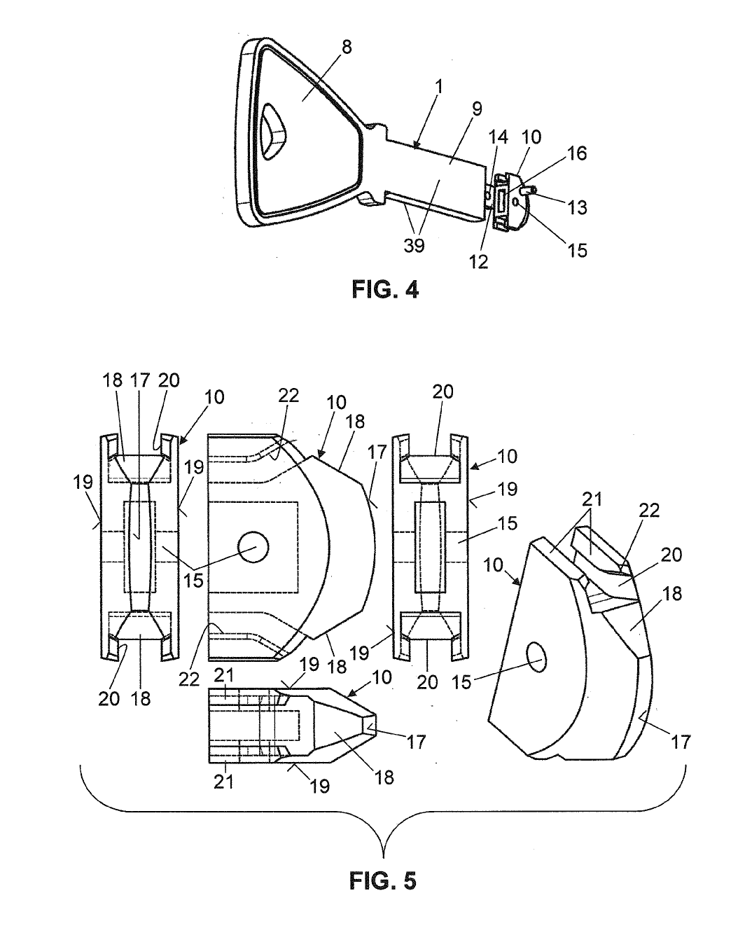

FIG. 4 shows a three-dimensional illustration of a security key according to the invention, wherein the tip is illustrated in the uninstalled state,

FIG. 5 shows different views of the tip of the security key,

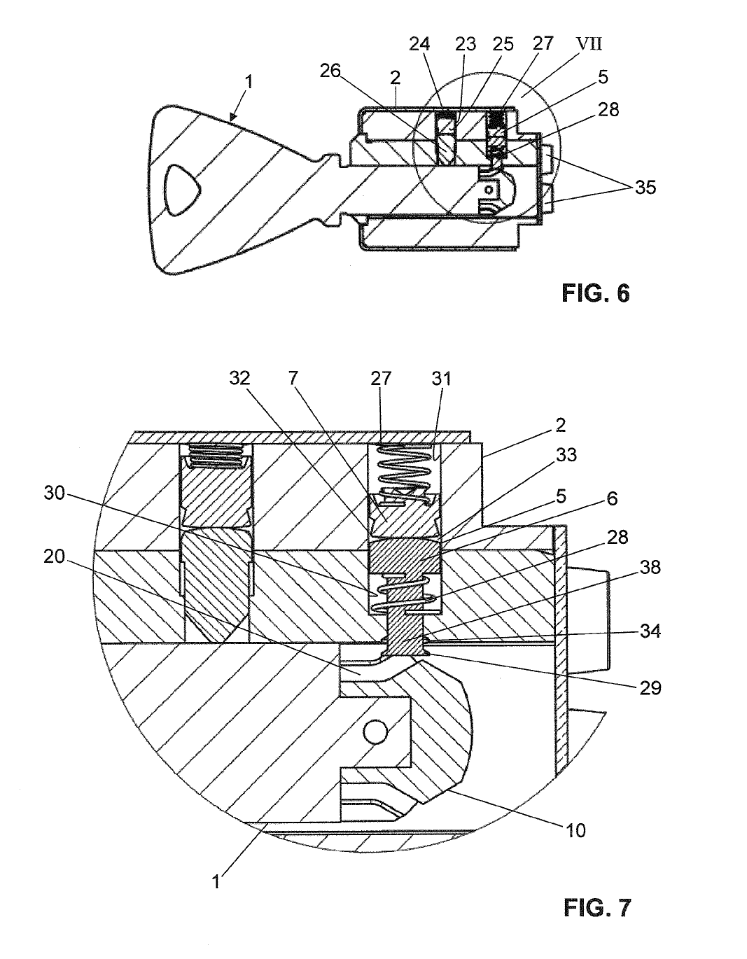

FIG. 6 shows, in longitudinal section, a rotary locking cylinder with an inserted security key,

FIG. 7 shows an illustration according to FIG. 1, but with a key inserted, wherein, as is apparent, the core pin is in the basic position and at the same time is in the engagement position,

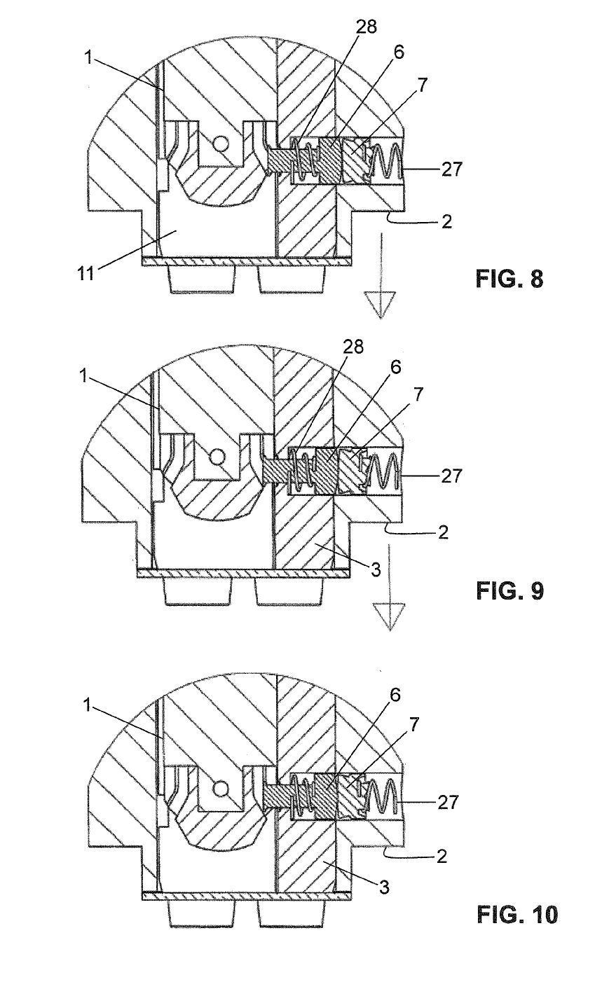

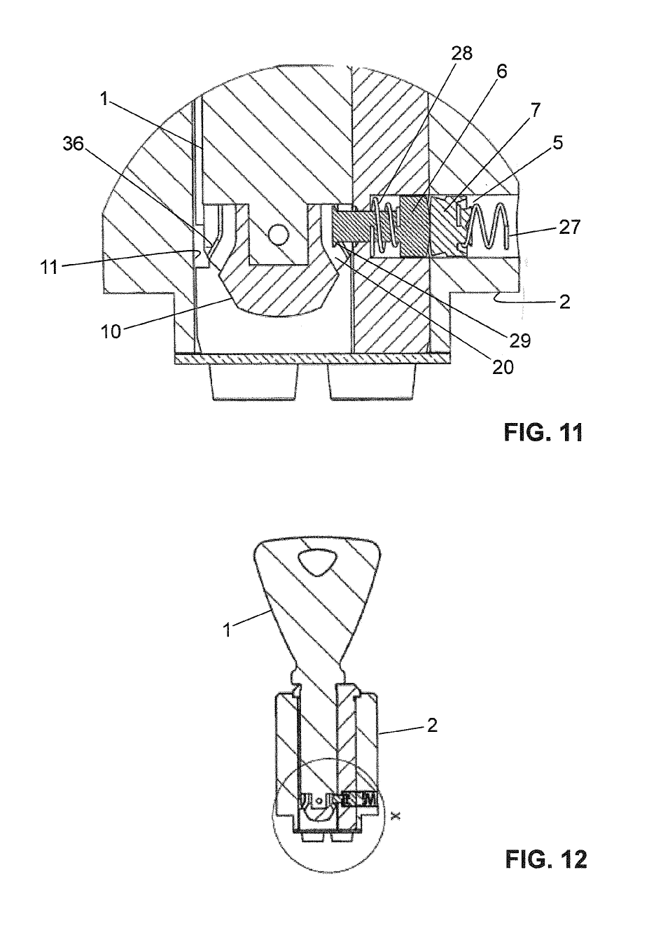

FIGS. 8-11 show sections according to FIG. 1, but with different positions of the security key and of the tumbler, wherein said tumbler is brought into line in FIG. 11, and the security key is correspondingly completely inserted into the keyway,

FIG. 12 shows a section according to FIG. 6, but here the security key is completely inserted into the rotary locking cylinder,

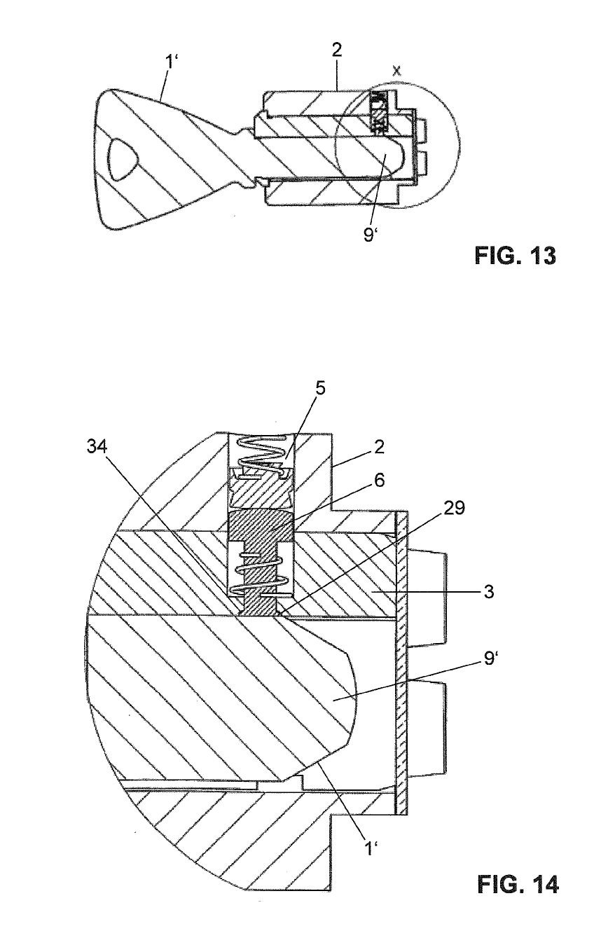

FIG. 13 shows a longitudinal section through a rotary locking cylinder according to the invention with a security key which is not according to the invention,

FIG. 14 shows an enlarged partial section of FIG. 13, and

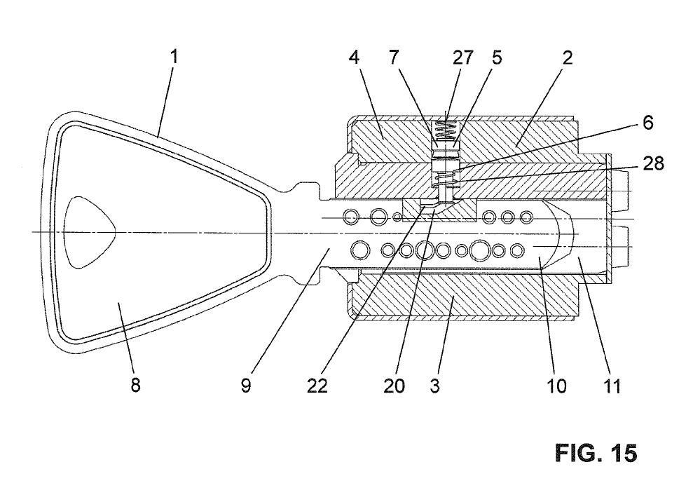

FIG. 15 shows a view of a further embodiment of the rotary locking cylinder.

The rotary locking cylinder 2 shown in FIGS. 1 to 3 has a rotor 3 with a key channel 11, in which, according to FIG. 3, a shank 9 of a security key 1 is partially inserted in the direction of the arrow 37. The rotary locking cylinder 2 has a number of tumblers 23 which are indicated merely by dashed lines here and each have, in a customary manner, according to FIG. 6, a core pin 26 and a housing pin 25. The housing pin 25 is loaded by a compression spring 24. Such tumblers 23 are generally known and do not need to be explained specifically here. In order to bring said tumblers 23 into line, the security key 1 has corresponding control surfaces, for example control surfaces in bores, by means of which the tumblers 23 are each pushed radially outward such that they release the rotor 3. The security key 1 is preferably a turning key, but it could also be a non-turning key, for example a toothed key.

The rotary locking cylinder 2 has at least one further tumbler 5 which is essential to the invention. Said tumbler likewise has, according to FIG. 1, a core pin 6 and a housing pin 7. The tumbler 5 is mounted in a radial bore 30 or 31. As is apparent, the bore 30 is a stepped bore. The housing pin 7 is loaded by a housing pin spring 27 which is supported on the housing 4. The approximately mushroom-shaped core pin 6 is positioned by a core pin spring 28 which is mounted displaceably in the bore 30. The housing pin spring 27 is substantially weaker than the core pin spring 28, and therefore, in the basic position, the core pin 6 according to FIGS. 1 and 3 projects with a front end 38 into the key channel 11. Said front end 38 has a peripheral collar 29 on the end side. In the basic position shown in FIG. 1, the rotor 3 is blocked by the core pin 6 and therefore in a positive manner. If all of the tumblers 23 and 5 are brought into line by the security key 1, the rotor 3 can be rotated by the security key 1 about the axis A indicated in FIG. 2.

In FIG. 1, the core pin spring 28 is at the maximum extent thereof, said extent being selected such that the core pin 6 is in a blocking position at the maximum extent. The housing pin spring 27, which can also be referred to as a security spring, ensures that the housing pin 7 is always in contact with the core pin 6. If the core pin is pulled too far into the key channel 11 during an attack attempt, the housing pin spring 27 presses the housing pin 7 into the rotor 3 and blocks same.

When the shank 9 is inserted into the key channel 11, the tumblers 23, as already mentioned, are brought into line in a customary manner by pushing. In order to bring the tumbler 5 into line, a key tip 10, which is explained in more detail below, is arranged at the front end of the shank 9.

In addition, the radial planes R1 and R2 are shown in FIG. 2. The radial planes R1, R2 extend through the center axis or the axis of rotation of the rotor 3. The tumblers 5, 23 can be brought into line radially in different directions by the security key 1. Radially should be understood as meaning that the tumblers 5, 23 lie with the center axes thereof on the radial plane R1, R2 and are therefore movable in the radial plane R1, R2. Said tumblers 5, 23 are formed in a rotationally symmetrical manner with respect to the center axis of same, and therefore the tumblers 5, 23 cannot be arranged in a positionally precise manner with respect to the alignment about said center axis.

According to FIG. 4, the tip 10 is fastened releasably to a fastening tab 12 of the key shank 9 by means of a fastening pin 13. In order to receive the fastening tab 12, the key tip 10 has a recess 16. The pin 13 is inserted into a bore 15 in the key tip 10 and into a bore 14 in the fastening tab 12. In this case, the key tip 10 is therefore exchangeable. However, it can also be fixedly connected to the shank 9 or worked directly out of the shank 9.

As FIG. 5 shows, the key tip 10 also has an end side 17 which is adjoined laterally in each case by a ramp 18 which is customary per se.

The ramps 18 are followed by a groove 20 which is arranged on a narrow side of the shank 9 and substantially extends in the longitudinal direction of the shank 9. Two opposite control parts 21 (FIG. 5) which each have a control surface 22 on the inside project in each case into the groove 20. The width of the groove 20 is matched to the width of the front end and to the collar 29. The front end 38 can be grasped, according to FIG. 7, by the groove 20. If the security key 1 in FIG. 7 is pushed further to the right, the front end 38 of the core pin 6 is grasped by way of the collar 29 and controlled. The core pin spring 28 is tensioned in the process while the housing spring 27 is relaxed. During the bringing the tumbler into line, the core pin 6 and the housing pin 7 bear against each other under tension. Since the core pin 6 is mechanically positioned by the comparatively strong core pin spring 28, it cannot be moved, for example, by means of impact or vibration or other manipulations. The movement controlled by the security key 1 is therefore controlled. By means of this control, the core pin 6 and, with the latter, the housing pin 7 are moved inward out of the position shown in FIG. 7 and, as a result, are brought into line. As is apparent, in the position according to FIG. 7, the core pin 6 blocks the rotor 3. By means of this control or radial movement of the core pin 6, said blocking is eliminated, and therefore the rotor 3 can finally be rotated. Individual steps of this movement are illustrated in FIGS. 8 to 11.

FIG. 8 shows the position of the core pin 6 in the position which is already shown in FIG. 7. If the security key 1 is then pushed further into the key channel 11, the core pin 6 is drawn inward and therefore the core pin spring 28 is compressed. In FIG. 9, the core pin 6 continues to block the rotor 3. If the security key 1 is pushed even further into the key channel 11, the core pin 6 reaches the position shown in FIG. 10. The core pin 6 is brought into line here and no longer blocks the rotor. The housing pin 7 bears against the housing pin spring 27 during the radial movement of the core pin 6 because of the force of said housing pin spring. Finally, the security key 1 is pushed into the end position shown in FIGS. 11 and 12. The security key 1 bears here, as customary (not shown here), against the rotor head. The tumbler 5 and also the remaining tumblers 23 are then brought into line and the rotor 3 can therefore be rotated. At the same time, drivers 35 (FIG. 1) which actuate a bolt in a manner known per se are rotated by the rotor 3.

In the manner shown, two opposite tumblers 5 can be brought into line at the same time by the security key 1. In principle, an embodiment in which the tumbler 5 is further away from the end side 17 is also conceivable. More than two such tumblers 5 can also be provided. As is apparent, the security key 1 is what is referred to as a turning key; however, this is not compulsory.

FIGS. 13 and 14 show the rotary locking cylinder 2, into which here, however, a security key 1′ which has a customary key shank 9 and in which the key tip 10 is not present or which is designed as customary is inserted. The tumbler 5 is moved completely outward by said key 1′, and therefore the collar 29 sits in a recess 34. The core pin 6 is pushed outward and blocks the rotor 3. The rotor therefore cannot be rotated by the security key 1′ and, accordingly, the associated lock cannot be opened. This is true even if the customary tumblers 24 are brought into line. If the security key 1′ is pulled out, the tumbler 5 is moved again into the basic position shown in FIG. 1. In said basic position, the core pin 6 then blocks the rotor 3. If the key shank 9′ is pulled out of the rotary locking cylinder 2, the tumbler 5 is moved by the force of the housing spring 5 into the basic position shown in FIG. 1. The core pin 6 can be produced, as customary, from a suitable metal, for example steel or the like. For simpler installation, said core pin can be in multipart form. The front part 38 can be inserted, for example, into the head-shaped part and soldered. The rotary locking cylinder 2 can be a single cylinder or a double locking cylinder. It can also be designed as an electromechanical rotary locking cylinder.

A further embodiment of the rotary locking cylinder 2 and of the security key 1 is shown in FIG. 15. Identical parts are provided here with the same reference numbers. The main difference over the embodiments shown previously is the positioning of the control surface 22. The control surface 22 here is not arranged in the region of the key tip 10, but rather in the region of the key shank 9. This arrangement also results in the tumbler 5 corresponding with the control surface 22 likewise being arranged at a different position.

The radial cam 22 here is part of a recess or groove 20 arranged in the key shank 9. The radial cam is arranged in turn on both sides of the edgeways side of the key shank 9.

When the security key 1 is pushed into the key channel 11, in a first step, the housing pin 7 and core pin 6 of the tumbler 5 are moved radially outward in the radial plane R1 counter to the action of the housing pin spring 27. As soon as the recess 20 comes to lie level with the tumbler 5, said tumbler is pushed owing to the action of the housing pin spring 27 into the recess 20, in which the core pin 6 then comes into contact with the radial cam 22, as a result of which the tumbler 5 is then brought into line.

When the security key 1 is pulled out, the tumbler 5 is moved radially outward because of the action of the core pin spring 28, until the core pin 6 has completely left the key channel 11.

It is also conceivable for a further embodiment to arrange a plurality of tumblers 5 and a plurality of matching radial cams 22, and therefore the locking permutation can be increased. The radial cams 22 can be arranged here in the key shank 9 and in the key tip 10.

### LIST OF DESIGNATIONS

1 Security key
2 Rotary locking cylinder
3 Rotor
4 Housing
5 Tumbler
6 Core pin
7 Housing pin
8 Key handle
9 Key shank
10 Key tip
11 Keyway
12 Fastening tab
13 Fastening pin
14 Bore
15 Bore
16 Recess
17 End side
18 Ramp
19 Side surface
20 Groove
21 Control part
22 Control surface
23 Tumbler
24 Spring
25 Housing pin
26 Core pin
27 Housing pin spring
28 Core pin spring
29 Collar
30 Bore
31 Bore
32 Surface
33 Surface
34 Recess
35 Driver
36 Stop
37 Arrow
38 Front end
39 Side surfaces
R1 Radial plane
R2 Radial plane
A Rotor axis

1.-20. (canceled)

21. A rotary locking cylinder and security key, the rotary locking cylinder comprising:
a housing;
a rotor mounted in the housing;
at least two tumblers which influence combinatorics and each comprise a core pin and a housing pin; and
a key channel incorporated into the rotor,
wherein said at least two tumblers are brought in line by the security key being pushed into the key channel, and
wherein said at least two tumblers, while mechanically controlled by the security key, are brought in line radially in different directions.

22. The rotary locking cylinder as claimed in claim 21, wherein the at least two tumblers lie in at least one common radial plane or in a plurality of different radial planes running through the rotor axis of the rotor and are brought in line radially in the radial planes.

23. The rotary locking cylinder as claimed in claim 21, wherein at least one of the tumblers is drawn radially inward by the security key for displacement purposes to bring the tumblers in line.

24. The rotary locking cylinder as claimed in claim 21, wherein the core pins and the housing pins of the tumblers are of rotationally symmetrical design with respect to the center axis thereof.

25. The rotary locking cylinder as claimed in claim 21, wherein at least one of the tumblers is grasped by a front key tip or by a key shank of the security key and is brought in line.

26. The rotary locking cylinder as claimed in claim 21, wherein at least one of the tumblers is moved radially inward out of a basic position by the security key for bringing said tumbler in line by a control means of the security key.

27. The rotary locking cylinder as claimed in claim 21, wherein the security key has a key tip which is produced separately and is fastened to the security key.

28. The rotary locking cylinder as claimed in claim 27, wherein the key tip is produced from a harder material than the remaining region of the security key.

29. The rotary locking cylinder as claimed in claim 27, wherein the key tip is fastened releasably to a shank of the security key and is exchangeable.

30. The rotary locking cylinder as claimed in claim 21, wherein the security key is a turning key or a non-turning key.

31. The rotary locking cylinder as claimed in claim 21, wherein the security key has opposite, identical control means on a key tip or on a key shank.

32. The rotary locking cylinder as claimed in claim 21, wherein, for bringing the at least one tumbler in line, a key tip or a key shank has at least one radial cam with which said tumbler is movable radially inward to a locking height.

33. The rotary locking cylinder as claimed in claim 32, wherein the radial cam is arranged at a front end of the key tip.

34. The rotary locking cylinder as claimed in claim 32, wherein the at least one radial cam is arranged on each edgeways side of the security key, the radial cams being formed identically to one another.

35. The rotary locking cylinder as claimed in claim 32, wherein the radial cam is arranged with respect to the security key centrally to side surfaces of the security key.

36. The rotary locking cylinder as claimed in claim 21, wherein the at least one radially inwardly movable tumbler has a housing pin spring and a core pin spring, wherein the core pin spring is substantially stronger than the housing pin spring, and wherein the core pin spring holds the core pin in a basic position, in which a front end of the core pin projects into the key channel.

37. The rotary locking cylinder as claimed in claim 21, wherein at least one narrow side of the security key has a groove in which an end of a core pin, said end projecting into the key channel, is controllable by the control surface, and is drawable to the locking height when the security key is pushed into the key channel.

38. The rotary locking cylinder as claimed in claim 37, wherein the groove is arranged at a front end of the security key or at a distance from said front end.

39. The rotary locking cylinder as claimed in claim 21, wherein at least one core pin of the at least one tumbler has a control means on an inner end projecting into the key channel, by which the core pin can be grasped by the security key and brought in line.

40. The rotary locking cylinder as claimed in claim 21, wherein at least one of the tumblers has a core pin which interacts with a compression spring which is supported on the rotor and on the core pin and positions the core pin in a basic position, and wherein the core pin blocks the rotor in said basic position.
